(19) United States
(12) Patent Application Publication
(10) Pub. No.: US 2004/0190590 A1
(43) Pub. Date: Sep. 30, 2004

(54) Apparatus for determining the temperature of a flowing medium in conduit and method for producing the apparatus

(75) Inventors: Karl-Heinz Wienand, Aschaffenburg (DE); Gernot Hacker, Budingen (DE); Matthias Muziol, Mainhausen (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Heraeus Sensor Technology GmbH

(21) Appl. No.: 10/812,482

(22) Filed: Mar. 30, 2004

(30) Foreign Application Priority Data
Mar. 31, 2003 (DE) 103 14 705.5

(51) Int. Cl. G01K 17/00; G01L 7/00

(52) U.S. Cl. 374/147

(57) ABSTRACT

An apparatus is provided for determining the temperature of a flowing medium in a pipe or tube conduit. The apparatus has a sensor element formed from a ceramic substrate and a thin-film resistor arranged on the substrate and electrically and mechanically connected to at least two electrical leads. The sensor element is arranged in a plastic housing having an opening at least for the pipe or tube and being formed as a molded part. The electrical leads are formed from metal strips, each having first and second ends, with the sensor element arranged at the first end of the metal strips. The plastic housing is molded around the metal strips in a region between their first and second ends, and preferably forms a plug at the second end of the metal strips. Methods are also provided for producing the apparatus, wherein the first end of the metal strips may be bent up about 90° before the molding the housing around the metal strips, and optionally around the conduit, and then bent back again after molding and connected to the conduit by a heat-conductive material.

Apparatus for Determining the Temperature of a Flowing Medium in a Conduit and Method for Producing the Apparatus

### BACKGROUND OF THE INVENTION

The invention is directed to an apparatus for determining the temperature of a flowing medium in a pipe or tube conduit. The apparatus has a sensor element, which is formed from a ceramic substrate and a thin-film resistor arranged on this substrate and is electrically and mechanically connected to at least two electrical leads. The sensor element is arranged in a plastic housing, which has an opening at least for the pipe or tube conduit. The invention is further directed to a suitable method for producing such an apparatus.

Apparatuses of the type mentioned above are known from German Patent DE 100 29 186 C2. This patent discloses a temperature sensor, which is directly mounted on strip conductors on the exterior of a pipe. A separate housing completely encloses both the temperature sensor and the pipe and simultaneously provides tension relief for a connection cable of the temperature sensor.

German Utility Model DE 299 14 553 U1 discloses an external temperature sensor in a tubular housing, which is set flush on a pipe to be measured. Here, the electrical unit is integrated on a ceramic substrate in the tubular housing.

U.S. Pat Nos. 6,334,707 and 5,454,641 disclose a temperature sensor, which is mounted on a pipe by a C-shaped retaining clamp. Here, the contact surfaces of the parts containing the temperature sensor are adapted to the pipe in a form-fitting manner.

U.S. Patent No. 5,244,276 discloses a temperature sensor in a housing, which is adhered to a pipe. Here, the housing does not enclose the pipe.

U.S. Patent No. 5,993,061 discloses a temperature sensor, which is inserted into a bushing welded to the surface of a pipe. The temperature sensor is thereby fixed in its position and pressed against the pipe surface.

U.S. published patent application 2002/0041621 A1 discloses a housing made of plastic, which serves for receiving a pipe or tube conduit and a temperature sensor. Here, the housing has a cover.

U.S. published patent application 2002/0064206 A1 discloses a temperature sensor on a pipe surface. This sensor is arranged in a housing enclosing the pipe. Here, the temperature sensor is surrounded in the housing by heat-insulating material.

German utility model DE 83 10 279.5 discloses a temperature sensor, which is mounted on a pipe with a pipe clamp. The sensor is fixed by spring force via a heat-conducting piece.

German published patent application DE 33 16 995 A1 discloses a temperature sensor, which penetrates directly into the pipe cross section of a pipe as an immersion sensor. Here, an injection-molded part is provided around the temperature sensor. This application further discloses a connection for the temperature sensor via a plug.

### BRIEF SUMMARY OF THE INVENTION

An object of the invention is to provide another apparatus for measuring the temperature of media flowing in pipe or tube conduits. In particular, this apparatus should be both simply and economically produced and installed. A further object is to provide a suitable method for producing such an apparatus.

The object is achieved for the apparatus in that the plastic housing is formed as a molded part, preferably injection-molded, and that the electrical leads are formed of metal strips, each having a first and a second end. The sensor element is arranged at the first end of the metal strips, and the metal strips are encased by injection molding of the plastic housing in a region between their first and second ends.

It is advantageous for such an apparatus if the number of necessary components is extremely low and if the production can be automated. As a material for the thin-film resistor, preferably platinum or a platinum alloy is used. Due to its relatively low heat conductivity, constantan has been found to be effective as the material for the metal strips.

Such an apparatus is preferably used for measuring temperatures in a range of 40° C. to +180° C. and is employed, for example, as an economical fuel-temperature sensor in motor vehicles.

In particular, it has been found to be effective if both the sensor element and a pipe or tube conduit section (hereinafter “conduit section”) for installation in the pipe or tube are arranged in the opening, with the sensor element and the conduit section being connected to each other by a heat-conductive material. The use of heat-conductive paste, heat-conductive film, or highly heat-conductive silicone rubber has been found to be effective for the heat-conductive material.

It has further been found to be effective if the plastic housing is molded around the conduit section in at least one region along its outer diameter. A mechanically solid connection is thereby formed between the plastic housing and the conduit section, so that further measures for fixing the conduit section can be omitted.

In terms of the smallest possible number of components that can be used for the apparatus, it has been found to be effective to form the plastic housing as a plug in the region of the second end of the metal strips for connecting the metal strips to an electrical connection cable.

To protect the measurement region from mechanical effects, it has been found to be effective to close the opening with a cover.

The object related to a method for producing the apparatus, wherein both the sensor element and a conduit section for installation in a tube or pipe are arranged in the opening, and wherein the sensor element and the conduit section are connected to each other via a heat-conductive material, is achieved by bending the metal strips a first time in a region between their first and second ends, by then molding the plastic housing around the metal strips in the region between their first and second ends and around the conduit section in at least one region along its outer diameter, preferably by injection molding, by then bending the first end of the metal strips a second time, such that the first end is placed near the conduit section, and by providing heat-conductive material into the opening, so that the conduit section and the sensor element are connected to each other by the heat-conductive material.

The object related to another method for producing an apparatus, wherein both the sensor element and a conduit section for installation in a pipe or tube are arranged in the opening, and wherein the sensor element and the conduit section are connected to each other via a heat-conductive material, is achieved by bending the metal strips a first time in a region between their first and second ends, by then molding the plastic housing around the metal strips in the region between their first and second ends, preferably by injection molding, by then laying a conduit section in the opening, by bending the first end of the metal strips a second time, such that the first end is placed near the conduit section, and by providing an amount of heat-conductive material in the opening, so that the conduit section and the sensor element are connected to each other by the heat-conductive material.

The assembly of the sensor element can be performed before the first bending of the metal strips. However, this can lead to damage of the connection between the metal strips and the sensor element during the bending process. Therefore, an assembly of the sensor element is preferred only after the second bending of the metal strips. The heat-conductive material in the form of a heat-conductive paste is advantageously set into the opening only after the assembly of the sensor element.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a longitudinal side sectional view of one embodiment of an apparatus according to the invention;

FIG. 1a is a plan view of the apparatus of FIG. 1 without a cover;

FIG. 1b is an end view of the apparatus of FIG. 1, as seen from the plug;

FIG. 1c is a partial sectional view of the apparatus of FIG. 1 before assembly of the sensor element;

FIG. 2 is a longitudinal side sectional view of another embodiment of an apparatus according to the invention;

FIG. 2a is a plan view of the apparatus of FIG. 2 without a cover, as seen from below; and

FIG. 2b is an end view of the apparatus of FIG. 2, as seen from the plug.

### DETAILED DESCRIPTION OF THE INVENTION

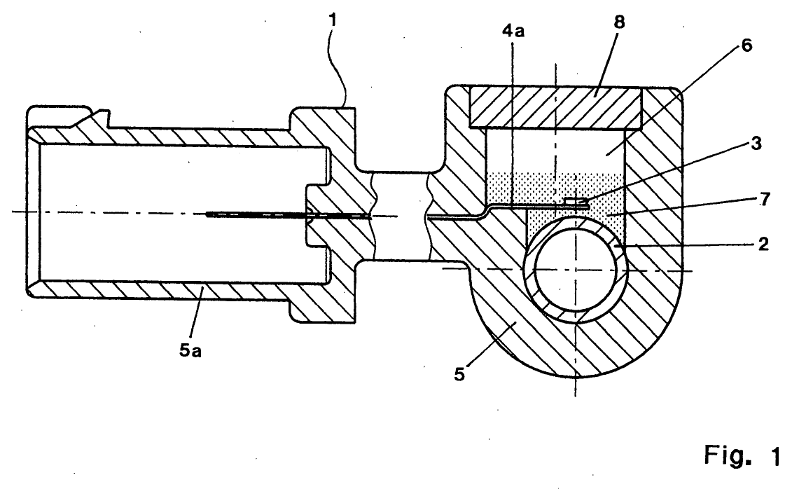

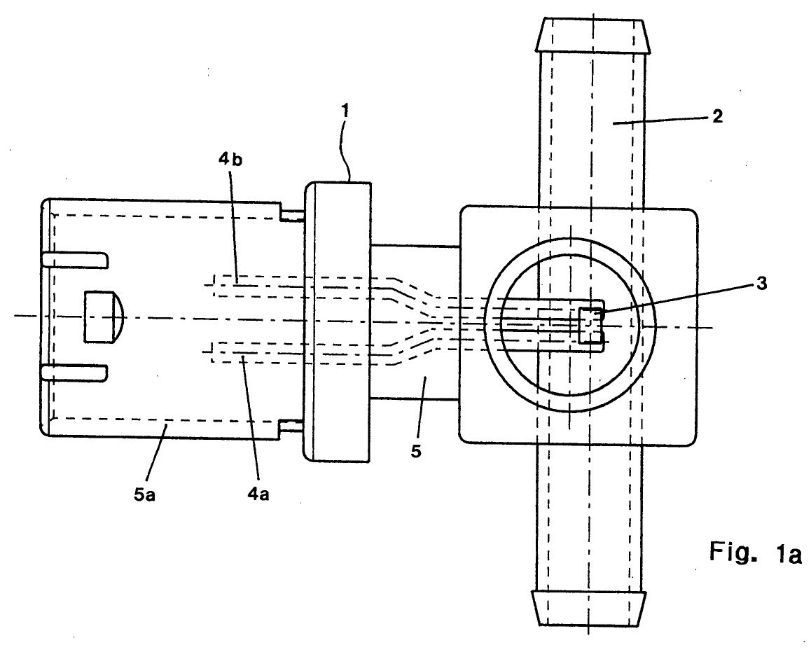

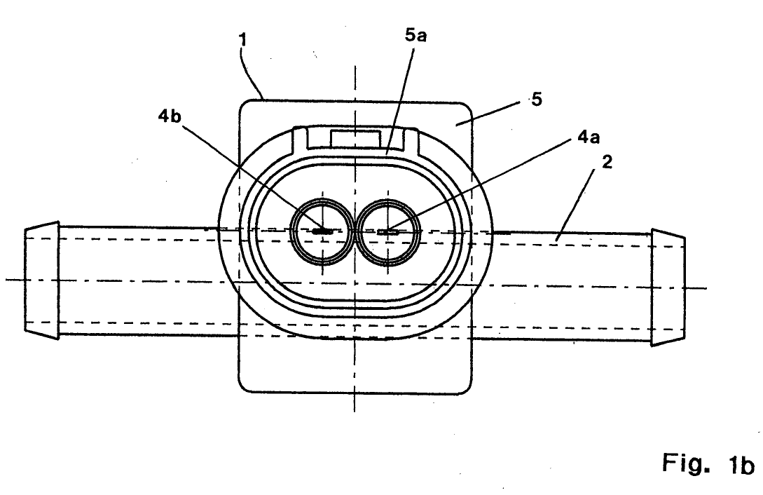

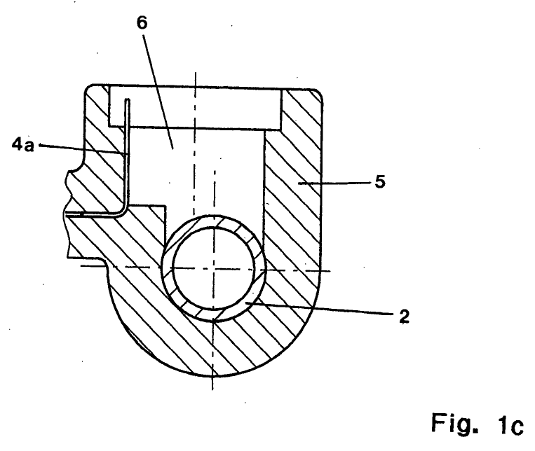

FIG. 1 shows a longitudinal side section of an apparatus 1 for determining the temperature of a flowing medium in a pipe or tube conduit or in a pipe or tube conduit section (“conduit section 2”). Here, a sensor element 3 is present, which is formed of a ceramic substrate and a platinum thin-film resistor arranged on the substrate. The sensor element 3 is electrically and mechanically connected to two metal strips 4a,, 4b (see FIG. 1a,), with the sensor element 3 spanning the two metal strips 4a, 4b like a bridge at one of their ends. The metal strips 4a, 4b are embedded in a plastic housing 5 in a region between the opposite ends of the strips, wherein the plastic housing 5 is formed by molding around the metal strips 4a, 4b. A mechanically solid connection is thereby formed between the plastic housing 5 and metal strips 4a, 4b. In the region of the ends of the metal strips 4a, 4b facing away from the sensor element 3, the plastic housing 5 is shaped in the form of a plug 5a, which allows a simple connection to an electrical connection cable (not shown here). The sensor element 3 is located in an opening 6 in the plastic housing 5 in the immediate vicinity of the conduit section 2 to be measured. Here, the sensor element 3 and the conduit section 2 are connected to each other by a heat-conductive material 7. A cover 8 closes the opening 6 and protects the sensor element 3 from mechanical damage from the outside.

FIG. 1a shows the apparatus 1 of FIG. 1 in plan view without cover 8.

FIG. 1b shows the apparatus 1 of FIG. 1 in end view, as seen from the plug 5a.

FIG. 1c shows a partial sectional view of the apparatus 1 of FIG. 1 before assembly of the sensor element 3. This illustration helps explain the method for producing the apparatus 1 according to the invention. The metal strips 4a, 4b are bent a first time in the region between their first and second ends and the plastic housing 5 is molded around them in the region between their first and second ends. Simultaneously, the plastic housing 5 is molded around the conduit section 2. After the molding, the first end of the metal strips 4a, 4b is bent a second time in the direction towards the conduit section 2. The sensor element 3 is then placed on the metal strips 4a, 4b near the conduit section 2. An amount of heat-conductive material 7 is provided in the opening 6, so that the conduit section 2 and the sensor element 3 are connected by the heat-conductive material 7.

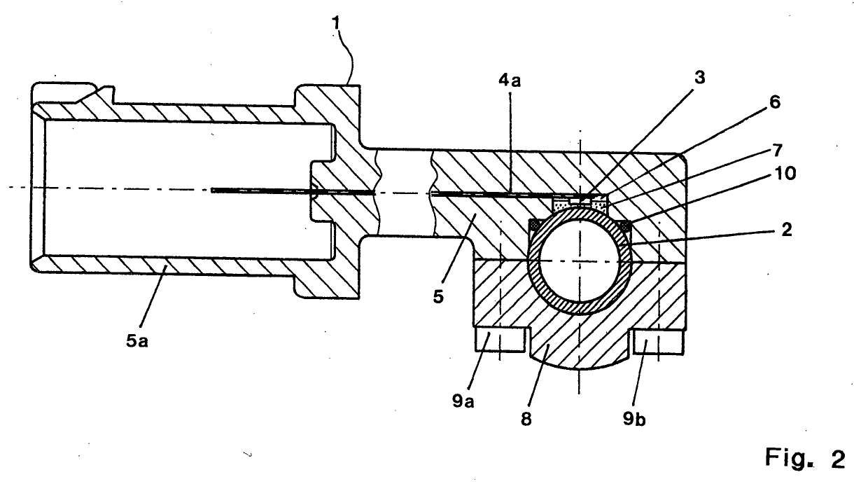

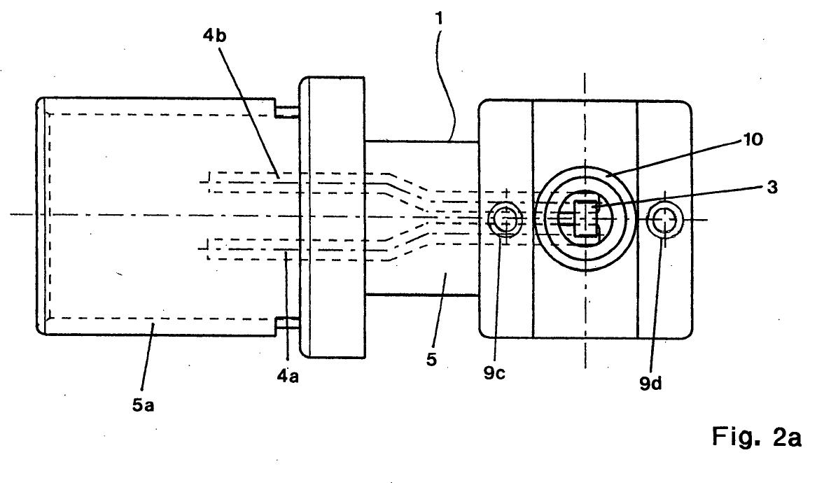

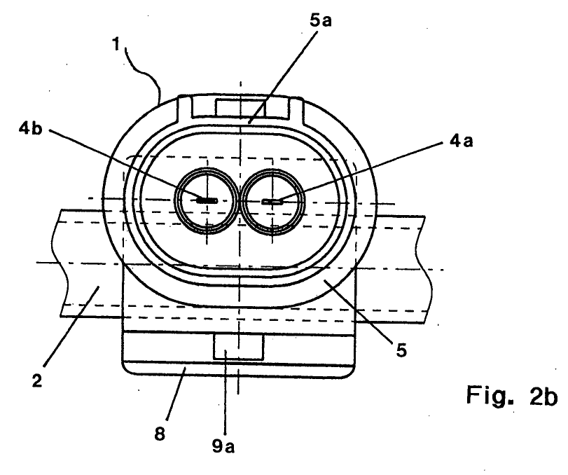

FIG. 2 shows a longitudinal section view of another apparatus according to the invention for determining the temperature of a flowing medium in a conduit section 2. During the production of this apparatus, the metal strips 4a, 4b are not bent. Here, a sensor element 3 is present, which is formed of a ceramic substrate and a platinum thin-film resistor arranged on the substrate. The sensor element 3 is electrically and mechanically connected to the metal strips 4a, 4b (see FIG. 2a), with the sensor element 3 spanning the two metal strips 4a, 4b like a bridge at one of their ends. The metal strips 4a, 4b are embedded in a plastic housing 5 in a region between the opposite ends of the strips, wherein the plastic housing 5 is formed by molding around the metal strips 4a, 4b. A mechanically solid connection is thereby formed between the plastic housing 5 and the metal strips 4a, 4b. In the region of the ends of the metal strips 4a, 4b facing away from the sensor element 3, the plastic housing 5 is shaped in the form of a plug 5a, which allows a simple connection of an electrical connection cable (not shown here). The sensor element 3 is located in an opening 6 in the plastic housing 5 in the immediate vicinity of the conduit section 2 to be measured. Here, the sensor element 3 and the conduit section 2 are connected to each other by a heat-conductive material 7. A cover 8 closes the opening 6 and is attached from below with fastening screws 9a, 9b into the plastic housing 5. The cover 8 thereby fixes the conduit section 2 in the apparatus 1 and presses it against an O-ring 10. The O-ring 10 here seals the space around the sensor element 3.

FIG. 2a shows the apparatus 1 of FIG. 2 from below without cover 8, fastening screws 9a, 9b, heat-conductive material 7, or conduit section 2. Here, the attachment holes 9c, 9d for the fastening screws 9a, 9b can be seen.

FIG. 2b shows the apparatus 1 of FIG. 2 in end view, as seen from the plug 5a.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An apparatus for determining the temperature of a flowing medium in at least a section (2) of a pipe or tube conduit, comprising a sensor element (3) having a ceramic substrate and a thin-film resistor arranged thereon, at least two electrical leads electrically and mechanically connected to the sensor element, and a plastic housing (5) in which the sensor element is arranged and which has an opening (6) at least for the conduit section (2), wherein the plastic housing (5) is formed as a molded part, the electrical leads comprise metal strips (4a, 4b) having first and second ends, the sensor element (3) is arranged at the first end of the metal strips (4a, 4b), and the plastic housing (5) is molded around the metal strips (4a, 4b) in a region between their first and second ends.

2. The apparatus according to claim 1, wherein the conduit section (2) and the sensor element (3) are arranged in the opening (6), and the sensor element (3) and the conduit section (2) are connected to each other by a heat-conductive material (7).

3. The apparatus according to claim 2, wherein the plastic housing (5) is molded around the conduit section (2) in at least one region along its outer diameter.

4. The apparatus according to claim 1, wherein in a region of the second end of the metal strips (4a, 4b) the plastic housing (5) has a form of a plug (5a,) for connecting the metal strips (4a, 4b) to an electrical connection cable.

5. The apparatus according to claim 1, wherein the opening (6) is closed with a cover (8).

6. A method for producing an apparatus according to claim 2, comprising bending the metal strips (4a, 4b) a first time in a region between their first and second ends, molding the plastic housing (5) around the metal strips (4a, 4b) in the region between their first and second ends and around the conduit section (2) in at least one region along its outer diameter, bending the first end of the metal strips (4a, 4b) a second time to place the first end near the conduit section (2), and providing an amount of heat-conductive material (7) in the opening (6) to connect the conduit section (2) and the sensor element (3) to each other.

7. The method according to claim 6, comprising assembling the sensor element (3) to the first end before the first bending of the metal strips (4a, 4b).

8. The method according to claim 6, comprising assembling the sensor element (3) to the first end after the second bending of the metal strips (4a, 4b).

9. The method according to claim 6, wherein the metal strips (4a, 4b) are bent the first time by +90° from an original position, and the metal strips (4a, 4b) are bent the second time by -90° back to the original position.

10. A method of producing an apparatus according to claim 2, comprising bending the metal strips (4a, 4b) a first time in a region between their first and second ends, molding the plastic housing (5) around the metal strips (4a, 4b) in the region between their first and second ends, setting the conduit section (2) in the opening (6), bending the first end of the metal strips (4a, 4b) a second time to place the first end near the conduit section (2), and providing an amount of heat-conductive material (7) in the opening (6) to connect the conduit section (2) and the sensor element (3) to each other.

11. The method according to claim 10, comprising assembling the sensor element (3) to the first end before the first bending of the metal strips (4a, 4b).

12. The method according to claim 10, comprising assembling the sensor element (3) to the first end after the second bending of the metal strips (4a, 4b).

13. The method according to claim 10, wherein the metal strips (4a, 4b) are bent the first time by +90° from an original position, and the metal strips (4a, 4b) are bent the second time by -90° back to the original position.
